(19) United States
(12) Patent Application Publication
(10) Pub. No.: US 2022/0395419 A1
(43) Pub. Date: Dec. 15, 2022

(54) ASSISTIVE MOBILITY DEVICE

(71) Applicant: CHANGDE YIXIANG INDUSTRIAL CO., LTD., Hu Nan Province (CN)

(72) Inventor: JIN-SONG ZHOU, HU NAN PROVINCE (CN)

(21) Appl. No.: 17/344,246

(22) Filed: Jun. 10, 2021

(51) Int. Cl. A61H 3/04

(52) U.S. Cl. CPC A61H 3/04; A61H 2003/046; A61H 2201/0161; A61H 2201/1633

(57) ABSTRACT

An assistive mobility device includes a connecting assembly disposed between two frames of a frame assembly, first wheels, second wheels, a positioning assembly disposed between the frames and the connecting assembly, and a stop assembly disposed on the frame assembly. By engaging at least one locking unit and at least one engagement unit of the positioning assembly together, support rods of the connecting assembly are stably unfolded for further use. When the locking unit leaves the engagement unit, the support rods can be folded up, and respective frame bodies of the frames pivotally connected to respective support bodies thereof can also be collapsed by lying down, thereby reducing the bulk of the folded mobility device. The stop assembly serves to prevent random rotations of the second wheels while folding and unfolding the mobility device. Therefore, the mobility device is more convenient and useful to use.

### BACKGROUND OF THE INVENTION

### 1. Field of the Invention

This invention relates to a walking assistive device and relates particularly to an assistive mobility device.

### 2. Description of the Related Art

A mobility device such as a walking aid assists elders with limp legs and people with injured or disable limbs in walking. A Taiwanese Utility Model No. M432415 disclosed an improved walking device. The walking device includes two side frames, a front lateral rod, and a telescopic assembly. The side frame has a front leg, a rear leg, a top rod portion, and a first projecting member disposed on the front leg. The front lateral rod has a rod body, two side sleeves, and a cut-out section. The telescopic assembly has an inner rod, and an outer rod, and a button assembly. Users such as people with disabilities, injured people, and elders can walk with the aid of the walking device because the walking device can support part of the weight or the center of gravity of the users to relieve the burden added to their legs, which allows the users to move by themselves without other help. However, the use of the walking device is still limited and not convenient because of the combination of the disclosed correlated elements. For example, before a user walks with the aid of the walking device, he needs to lift up the whole walking device, supports the center of gravity with his own legs, and thence leans forwards to put down the whole walking device. By taking account of weak users such as disable, injured, or elder users, they are not physically strong enough to support their legs before using the walking device, with the result that they may lose their balance easily while leaning forwards. Thus, the walking aid still needs improvements.

### SUMMARY OF THE INVENTION

An object of this invention is to provide an assistive mobility device which is easy to use, carry, and store. The bulk of the assistive mobility device can be efficiently reduced while folding the mobility device up, and concurrently the convenience and the practicality thereof can be increased.

The assistive mobility device of this invention includes a frame assembly which has two frames spaced from each other, two first wheels each disposed on each of the frames, two second wheels each disposed on each of the frames, a connecting assembly disposed between the two frames, a positioning assembly disposed between the two frames and the connecting assembly, and a stop assembly disposed on the frame assembly. Each frame of the frame assembly includes a frame body with opposite upper and lower ends, a handle portion disposed at the upper end, and a support body pivotally connected to the lower end. A recess is formed at the lower end of the frame body, and a protrusion protrudes from the support body. The protrusion is placed in the recess so that the support body and the frame body are pivoted together. The first wheel and the second wheel are respectively disposed on opposite first and second sides of each support body. The connecting assembly includes two support rods. The support rods cross each other and are pivoted together by a fixing unit which serves as an axle while folding and unfolding the two support rods. The two support rods have respective bottoms pivotally connected to the two frames respectively. The frames of the frame assembly are spaced from each other to form a space. When the space reaches a maximum, the support rods are unfolded to present an extended X shape. When the space reaches a minimum, the support rods are folded to present a compact X shape. The positioning assembly includes two base units each fixed to the frame body, two connecting shafts extending outwards from the base units and pivotally connected to the support rods, at least one locking unit disposed on one connecting shaft, and at least one engagement unit disposed on one support rod. The engagement unit is adapted to be caught by the locking unit when the support rods assumes the extended X shape. The stop assembly includes a stop base spaced from each second wheel, a blocking unit inserted into the stop base and facing the second wheel, and an operating unit connected to the blocking unit. The blocking unit is driven by the operating unit to be movable between a release position and a constraint position. When the blocking unit reaches the constraint position, the rotation of the second wheel is prevented. When the blocking unit leaves the constraint position, the second wheel rotates freely.

By arranging the positioning assembly between the frame assembly and the two support rods, the locking unit catches the engagement unit to cause the two frames to stand on the ground stably while unfolding the support rods. This allows a user such as a disabled person to stand between the two frames and propel himself along. When the locking unit leaves the engagement unit, the support rods can be folded up by taking the fixing unit as the axle to reduce the space between the frames. The frame body of each frame can be collapsed towards each support body, and the blocking unit of the stop assembly can press against the second wheel to limit and prevent the rotation of the second wheel. Therefore, the assistive mobility device is easily converted into a collapsible form to reduce its bulk and increases the convenience of use and the practicality.

Preferably, a cavity can be formed on the support body of each frame, and a lodging unit can protrude from the bottom of each support rod, which is adapted to be lodged in the cavity for increasing the engagement between the support rods and the frames.

Preferably, two positioning rods can be arranged. Each positioning rod is arranged at a top of each support rod. The positioning rods rest against the base units when the extended X shape is assumed by unfolding the support rods. The positioning rods leave the base units while folding the support rods. It is also possible that a seat member is disposed between the two positioning rods so that the user can sit on the seat member for a convenient use.

### BRIEF DESCRIPTION OF THE DRAWINGS

FIG. 1 is a perspective view showing a first preferred embodiment of this invention;

FIG. 2 is a partial exploded view of the first preferred embodiment of this invention;

FIG. 3 is a side view of the first preferred embodiment showing that frame bodies are in a fully-collapsed form;

FIG. 4 is a side view of the first preferred embodiment showing that frame bodies stand upright;

FIG. 5 is a schematic view of the first preferred embodiment showing an extended X shape by unfolding support rods;

FIG. 6 is a schematic view of the first preferred embodiment showing a compact X shape by folding support rods;

FIG. 7 is a partial schematic view of the first preferred embodiment showing that a blocking unit leaves a second wheel to release the second wheel;

FIG. 8 is a partial schematic view of the first preferred embodiment showing that the blocking unit presses against the second wheel to limit the second wheel;

FIG. 9 is a perspective view showing a second preferred embodiment of this invention;

FIG. 10 is an enlarged and exploded view of an encircled portion A of FIG. 9;

FIG. 11 is a partial cross-sectional view of the second preferred embodiment of this invention;

FIG. 12 is a schematic view of the second preferred embodiment showing an extended X shape by unfolding support rods; and

FIG. 13 is a schematic view of the second preferred embodiment showing a compact X shape by folding support rods.

### DETAILED DESCRIPTION OF THE PREFERRED EMBODIMENTS

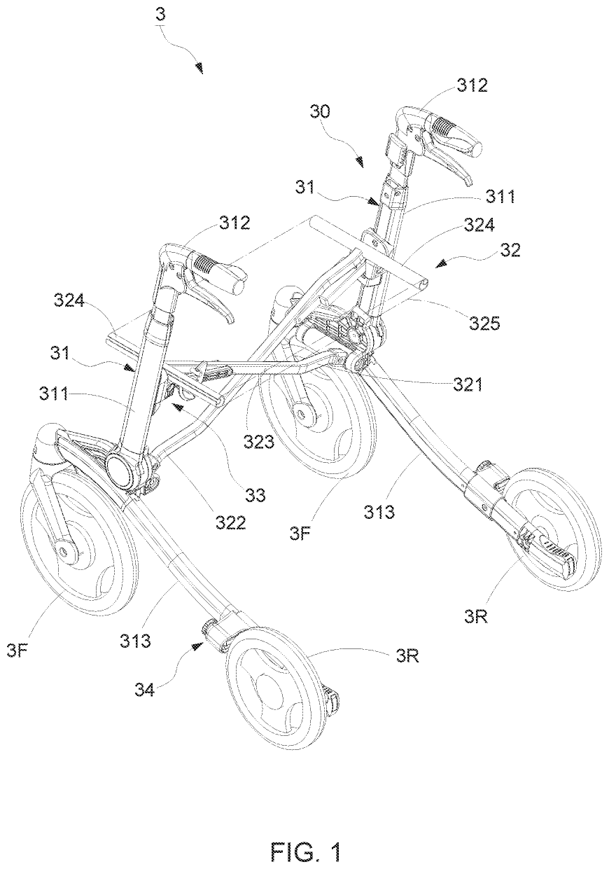

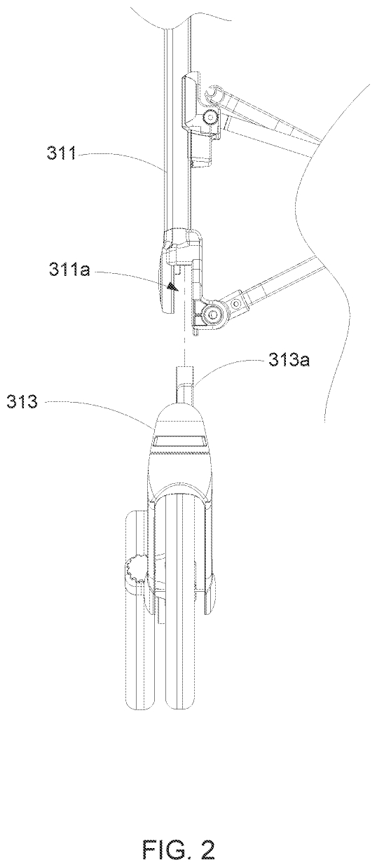

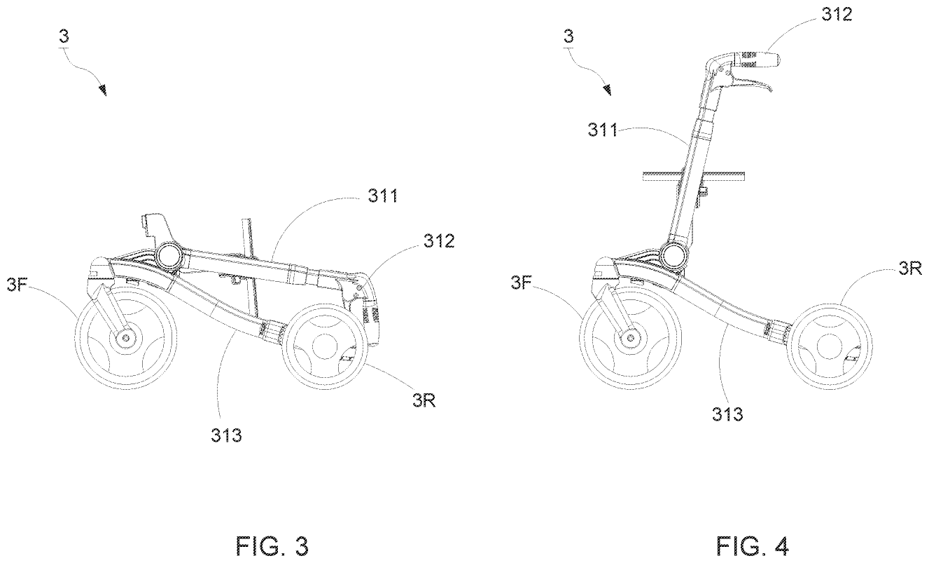

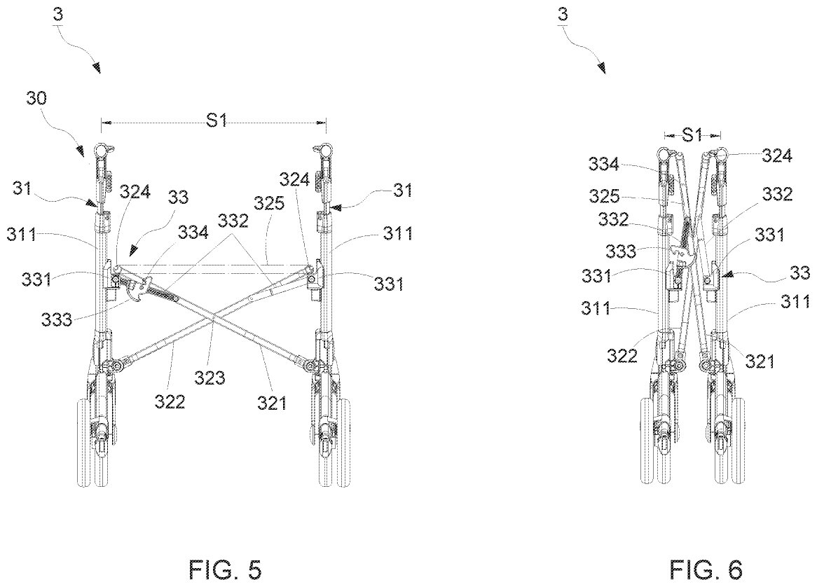

Referring to FIGS. 1 and 5, a first preferred embodiment of an assistive mobility device 3 includes a frame assembly 30 having two frames 31 spaced from each other to define an space S1 therebetween, first wheels 3F, second wheels 3R, a connecting assembly 32 disposed between the frames 31, a positioning assembly 33 disposed between the frames 31 and the connecting assembly 32, and a stop assembly 34 disposed on the frame assembly 30. Each of the two frames 31 includes a frame body 311 having an upper end and a lower end which are in opposite directions, a handle portion 312 disposed at the upper end of the frame body 311, and a support body 313 pivotally connected to the lower end of the frame body 311 and having a first side and a second side which are in opposite directions. Each of the first wheels 3F is disposed on the first side of the support body 313. The first wheel 3F herein can be deemed to be a front wheel. Each of the second wheels 3R is disposed on the second side of the support body 313. The second wheel 3R herein can be deemed to be a rear wheel. As shown in FIG. 2, at the lower end of the frame body 311 is formed a recess 311a adapted to receive a protrusion 313a which is a portion protruding from the support body 313. When the protrusion 313a is held by the recess 311a, the support body 313 and the frame body 311 are pivotally connected to each other. The pivotal connection serves as an axle whereby the frame body 311 stands upright (shown in FIG. 4) or lies down towards the support body 313 to be in a fully-collapsed form (shown in FIG. 3).

Referring to FIGS. 1, 5, and 6, the connecting assembly 32 includes two support rods 321, 322, namely a first support rod 321 and a second support rod 322, which cross each other. The support rods 321, 322 are pivoted together by a fixing unit 323 and are foldable by taking the fixing unit 323 as an axle. The two support rods 321, 322 have respective bottoms pivotally connected to the two frames 31 respectively. Specifically, a bottom of the first support rod 321 is pivotally connected to one frame 31, and a bottom of the second support rod 322 is pivotally connected to the other frame 31. As shown in FIG. 5, the support rods 321, 322 are unfolded to present an extended X shape, namely an open X state, and the space S1 has the maximum value. As shown in FIG. 6, the support rods 321, 322 are collapsed or folded up to present a compact X shape, namely a closed X state, and the space S1 has the minimum value. In other words, the space S1 between the two frames 31 reaches a maximum when the extended X shape is shown, whereas the space S1 reaches a minimum when the compact X shape is shown.

The positioning assembly 33 includes two base units 331, two connecting shafts 332, at least one locking unit 333, and at least one engagement unit 334. Each of the base units 331 is fixed to each frame body 311. The connecting shafts 332 extend outwards from the base units 331 respectively and are pivotally connected to the support rods 321, 322. The support rods 321, 322 and the connecting shafts 332 are respectively pivoted together by pivots. By the fixing unit 323 and the connecting shafts 332, the support rods 321, 322 can be stretched out to full length for presenting the extended X shape (FIG. 5) or closed up for presenting the compact X shape (FIG. 6). The locking unit 333 is disposed on one connecting shaft 332, and the engagement unit 334 is disposed on any designated support rod, namely the support rod 321 pivotally connected to the one connecting shaft 332 as shown. The locking unit 333 is adapted to catch the engagement unit 334 when the extended X shape is presented, thereby stabilizing the unfolding state. Alternatively, there can be more locking units 333 and more engagement units 334, and one locking unit 333 and one engagement unit 334 may be disposed on each of the connecting shafts 332 and on each of the two support rods 321, 322.

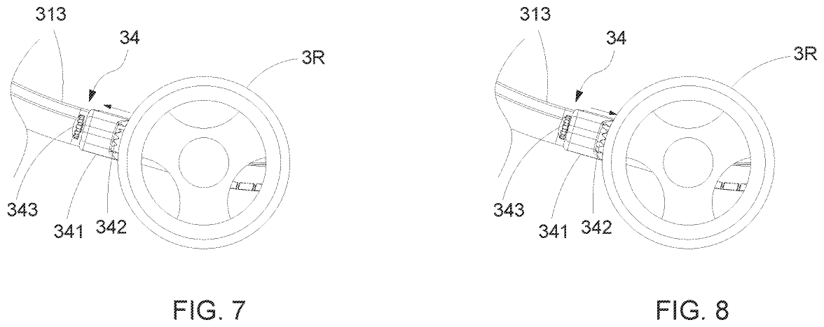

Referring to FIGS. 7 and 8, the stop assembly 34 includes a stop base 341 disposed on each support body 313 and spaced from each second wheel 3R, a blocking unit 342 inserted into the stop base 341 and facing the second wheel 3R, and an operating unit 343 connected to the blocking unit 343 and inserted into the stop base 341. The way of operating the operating unit 343 is not limited, and the blocking unit 342 is actuated by the operation of the operating unit 343, which allows the blocking unit 342 to be movable between a release position (FIG. 7) and a constraint position (FIG. 8). When the blocking unit 342 moves from the release position to the constraint position under the operation of the operating unit 343, the blocking unit 342 which reaches the constraint position presses against the second wheel 3R to limit the second wheel 3R, i.e. prevent the second wheel 3R from rotating randomly, as shown in FIG. 8. When the blocking unit 342 leaves the constraint position, the second wheel 3R rotates freely, as shown in FIG. 7.

There can be two positioning rods 324, each of which is arranged at a top of each of the two support rods 321, 322. The positioning rods 324 rest against the base units 331 when the support rods 321, 322 present the extended X shape. The two positioning rods 324 leave the base units 331 while folding the two support rods 321, 322. It is preferred that a seat member 325 can be disposed between the two positioning rods 324 so that a user sits on the seat member 325 when the two support rods 321, 322 are fully unfolded. The seat member 325 can be folded up by the folding action of the two support rods 321, 322. The seat member 325 can be made of a soft material or a hard material.

The operation of this invention is described with the aid of FIG. 3 through FIG. 8. FIG. 3 shows a fully-collapsed form when the assistive mobility device 3 is not used. To convert the device 3 from a non-use state into a use state, related actions are described as follows. By taking the place where the recess 311a and the protrusion 313a are pivoted as an axle, the frame bodies 311 are lifted to be perpendicular to support bodies 313, shown in FIG. 4. In other words, the frame bodies 311 stand upright. Then, the two frames 31 are moved outwards to opposite directions, with the result that the support rods 321, 322 are stretched out to full length for presenting the extended X shape shown in FIG. 5, the positioning rods 324 rest against the base units 331, and finally the seat member 325 are fully open. Meanwhile, the locking unit 333 is actuated to catch the engagement unit 334 for a locking engagement. Accordingly, the two frames 31 can be quickly unfolded and positioned in a stable manner, and the state of the unfolded support rods 321, 322 is not easily broken by improper external force. A user can then use the mobility device 3 freely by releasing each blocking unit 342 on each second wheel 3R with the operation of each operating unit 343, as shown in FIG. 7. Thus, the assistive mobility device 3 is freely propelled by the user, and rotations of the first wheels 3F and the second wheels 3R are actuated to assist the user in walking. A brake unit disposed on the handle portion 312 can also be controlled by the user to adjust the speed of the first wheels 3R, and this increases the safety of use.

After using the mobility device 3, the device 3 is collapsible so that the device 3 is easy to carry and store. Firstly, each blocking unit 342 is moved by the operation of each operating unit 343 and then presses against each second wheel 3R for providing limitation to the second wheels 3R, as shown in FIG. 8. This action allows the second wheels 3R to be fixed and prevents the second wheels 3R from rotating randomly, which facilitates the following folding action and also keeps the user from harm. Then, when the locking unit 333 leaves the engagement unit 334 for presenting an unlocking state, the two frames 31 are allowed to be moved inwards in the unlocking state, with the result that the support rods 321, 322 are folded up to small length for presenting the compact X shape shown in FIG. 6, and the positioning rods 324 also leave the base units 331 to close up the seat member 325. Finally, the frame bodies 311 can be put down toward the support bodies 313 to present the fully-collapsed form shown in FIG. 3. Thus, the collapsed form has the small bulk which occupies less space so that the device 3 is easily carried and stored and increases the convenience of use and the practicality.

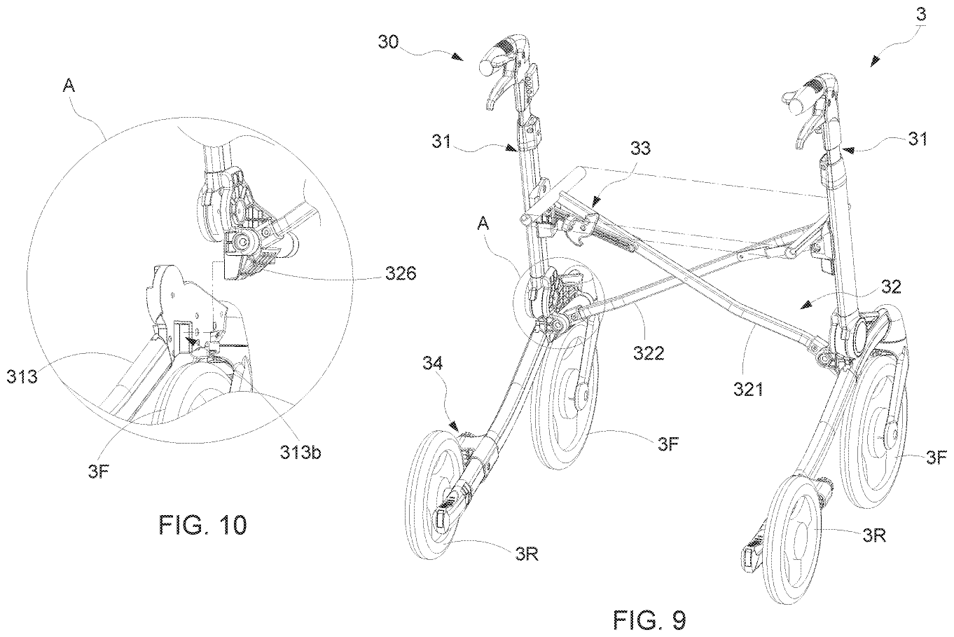

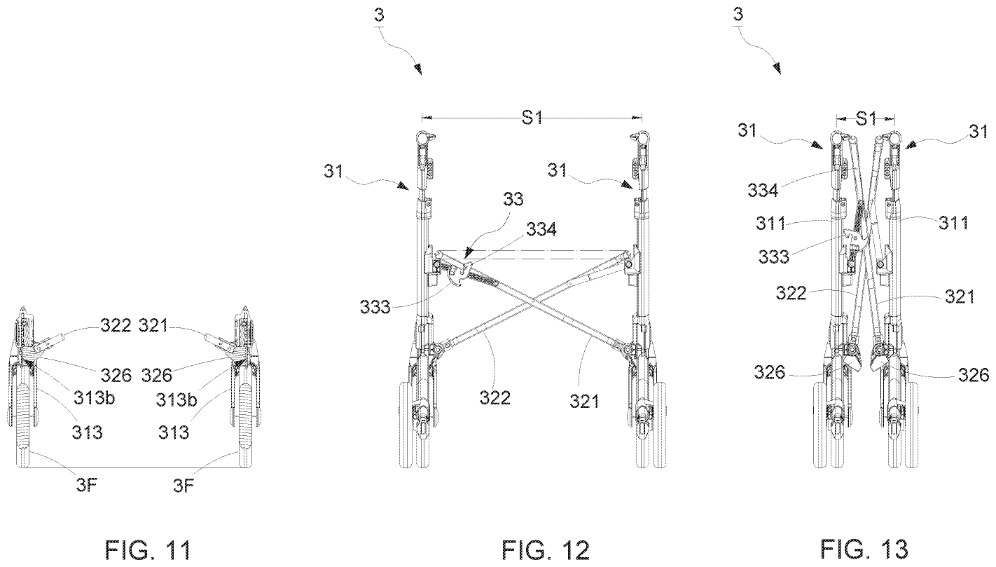

Referring to FIGS. 9 through 11, a second preferred embodiment of an assistive mobility device 3 is shown. The elements, the concatenation of correlated elements, and objectives and purposes of the second preferred embodiment are the same as those of the first preferred embodiment. In the second embodiment, it is characterized in that a cavity 313b is recessedly formed on each support body 313, and a lodging unit 326 protrudes from each bottom of each of the support rods 321, 322. In the figures, only one side view presenting a cavity 313b and a lodging unit 326 is seen, and the other side view is not seen. The lodging unit 326 is fitly lodged in the cavity 313b to ensure that two support rods 321, 322 are unfolded more stably when the extended X shape is presented, as shown in FIGS. 9 and 12. By this lodging action and the locking engagement of the positioning assembly 33, a stable engagement between the support rods 321, 322 and the two frames 31 is attained to promote the stability of the unfolded mobility device 3 and increase the safety of using the unfolded mobility device 3.

If the user does not want to use the mobility device 3, the folding action can be executed. The folding method of the second preferred embodiment is the same as that of the first preferred embodiment, which still includes limiting the second wheels 315 with the blocking units 342, then disengaging the engagement unit 334 from the locking unit 333, and thence moving the two frames 31 inwards for folding the support rods 321, 322 up. During the folding action, the lodging unit 326 is gradually removed from the cavity 313b. When the compact X shape is assumed, the lodging unit 326 leaves the cavity 313b completely, as shown in FIG. 13. Finally, each frame body 311 is also collapsible. Each frame body 311 can lie down towards each support body 313 to attain the fully-collapsed form, as for example shown in FIG. 3. Thus, the folding action is completed.

To sum up, the assistive mobility device of this invention takes advantage of the positioning assembly connected to both of the frame assembly and the connecting assembly and the stop assembly disposed on second wheels which are disposed on the frame assembly to facilitate a stable and safe unfolding action. The cooperation between the lodging unit and the cavity can also increase the stability and safety of using the unfolded mobility device. When the mobility device is to be folded up, the stop assembly is actuated to prevent random rotations of the second wheels, and the positioning assembly is unlocked to collapse the support rods of the connecting assembly, which allow the two frames of the frame assembly to be closed up. Therefore, the bulk can be efficiently reduced while folding the mobility device up, which not only increases the convenience and the practicality of using the mobility device but also attains the effect of carrying and storing the mobility device easily.

While the embodiments are shown and described above, it is understood that further variations and modifications may be made without departing from the scope of this invention.

What is claimed is:

1. An assistive mobility device comprising:
a frame assembly, said frame assembly including two frames spaced from each other to define an space therebetween, and said space being adjustable, wherein each of said two frames includes a frame body with opposite upper and lower ends, a handle portion disposed at said upper end of said frame body, and a support body pivotally connected to said lower end of said frame body and having opposite first and second sides, with a recess formed at said lower end of said frame body, with a protrusion protruding from said support body and configured to be inserted into said recess so that said support body is pivotally connected to said frame body;
a first wheel disposed on said first side of said support body of each of said two frames;
a second wheel disposed on said second side of said support body of each of said two frames;
a connecting assembly disposed between said two frames and including two support rods crossing each other and a fixing unit disposed at a place where said two support rods cross and serving as an axle while folding and unfolding said two support rods, said two support rods having respective bottoms pivotally connected to said two frames respectively, said two support rods being unfolded to present an extended X shape when said space between said two frames reaches a maximum, said two support rods being folded to present a compact X shape when said space reaches a minimum;
a positioning assembly including two base units each fixed to said frame body of each of said two frames, two connecting shafts extending outwards from said two base units and pivotally connected to said two support rods, at least one locking unit disposed on one of said two connecting shafts, and at least one engagement unit disposed on one of said two support rods and adapted to be caught by said at least one locking unit when said two support rods assumes said extended X shape; and
a stop assembly including a stop base disposed on said support body of each of said two frames and spaced from said second wheel, a blocking unit inserted into said stop base and facing said second wheel, and an operating unit connected to said blocking unit, with said blocking unit driven by said operating unit to be movable between a release position and a constraint position, a rotation of said second wheel being limited by said blocking unit when said blocking unit reaches said constraint position, said second wheel rotating freely when said blocking unit leaves said constraint position.

2. The assistive mobility device according to claim 1, wherein a cavity is formed on said support body of each of said two frames, a lodging unit protruding outwards from each of said respective bottoms of said two support rods and adapted to be lodged in said cavity.

3. The assistive mobility device according to claim 1, further comprising two positioning rods each arranged at a top of each of said two support rods, said two positioning rods resting against said two base units when said two support rods are unfolded to present said extended X shape, said two positioning rods leaving said two base units while folding said two support rods.

4. The assistive mobility device according to claim 2, further comprising two positioning rods each arranged at a top of each of said two support rods, said two positioning rods resting against said two base units when said two support rods are unfolded to present said extended X shape, said two positioning rods leaving said two base units while folding said two support rods.

5. The assistive mobility device according to claim 3, further comprising a seat member disposed between said two positioning rods.

6. The assistive mobility device according to claim 4, further comprising a seat member disposed between said two positioning rods.
